(19) United States
(12) Patent Application Publication
(10) Pub. No.: US 2015/0308472 A1
(43) Pub. Date: Oct. 29, 2015

(54) System, Method, and Apparatus for Joining Honeycomb Panels

(71) Applicant: Advent Aerospace, Inc., Rye, NH (US)

(72) Inventors: Michael Wayne Brace, St. Petersburg, FL (US); Steven M. Jourdenais, Redington Shores, FL (US)

(21) Appl. No.: 14/259,542

(22) Filed: Apr. 23, 2014

(51) Int. Cl. F16B 5/01; F16B 23/00

(52) U.S. Cl. CPC F16B 5/01; F16B 23/0023

(57) ABSTRACT

An adhesive-potted fastener and method for using such to join honeycomb core panels, where one of the two panels is secured on edge, at an angle to the surface of the second panel, includes a fastener having a head, cavity, threads, and through holes for the infusion of the adhesive potting compound. The fastener secures to the unreinforced honeycomb core in the honeycomb core panel normal to the surface of the second honeycomb core panel, holding the panels together until a proper amount of adhesive potting compound is flowed the interior of both panels. After curing of the adhesive potting compound, the physical attributes serve as a structural force-bearing member of an adhesive joint between the two honeycomb core panels in tension, torque and shear.

### FIELD

This invention relates to the field of aviation and more particularly to a system for joining two honeycomb core panels.

### BACKGROUND

Honeycomb core panels are a preferred choice of building panels in aerospace applications because of their high strength-to-weight ratio and their ability of mimic the properties of a solid panel through the separation of the inner and outer solid panel surfaces (skins) with a grid of thin, rigid walls (the honeycomb core). The outer and inner skins are adhered to the top and bottom edges of the honeycomb walls thus forming a very stiff, highly incompressible panel all the while being comprised mostly of cavities and a few thin laminates. Unfortunately, honeycomb panels have a weakness: honeycomb panels have no physical means by which to transmit a point [highly localized] load through their surfaces to another force-bearing member on the opposite side of the panel unless they are reinforced from the inside thus evenly and simultaneously distributing the load over a larger area and over both the inside and outside skins of the panel. This load-sharing construction serves to transfer loads to not only the skins of the honeycomb panel but to the interior walls of the honeycomb core as well as the adhesive bond between the honeycomb core and the panel skins.

U.S. Pat. Nos. 3,564,798, 4,812,193, 5,804,278, 6,264,412, 4,717,612 and 5,713,706 disclose various ways to affix various fasteners to honeycomb panels for the purpose of transmitting the load from the honeycomb panel to another load-bearing structure. In such, the use of an adhesive potting compound is prescribed for the retention of the fastener within the honeycomb panel. The use of an adhesive potting compound is the method of choice for many variants of fasteners in honeycomb panel construction.

In many cases, these aforementioned load bearing structures (such as flanges, threaded fasteners, other surfaces, etc.) are secured to the honeycomb panel with the use of an adhesive potting compound for the purpose of either mechanically holding (or securing) the honeycomb panel in place, or securing another load-bearing device to the honeycomb panel. The above references disclose various ways to affix a fastener to a single honeycomb panel, to distribute the ‘point’ load of the force member to the honeycomb panel, or fasteners for such, none of them provide a system for securing one honeycomb panel to another honeycomb panel, nor a system that does not require the use of supplemental fasteners when one of the honeycomb panels is affixed to the other on edge and in a non-planer direction to the other.

The common method of fabricating such a union between two honeycomb panels is very similar to that of wood cabinet construction: a through-hole is drilled through the surface of a first panel (surface panel) and a mating hole [of limited depth] is drilled in the edge of a second panel (herein referred to as the edge panel) to which the surface panel is desired to be affixed. Most screw-type fasteners (used to assemble panels using this method) typically require a pre-measured, precision pilot hole drilled in the edge panel for the fastener to pilot within to and affix to (when drawing the two panels together). Bonded pin-type fasteners also need a pre-measured, precision pilot hole in the edge panel but it is only for use when the fastener is bonded into the edge panel with adhesive, not screwed in.

In the first aforementioned scenario the fastener is most often a screw of specific type design to self-thread into the wood of the edge panel. In the second aforementioned scenario the pin (often referred to as a dowel) fastener is most often a dowel made from similar material (in this case wood) with a surface feature (or texture) circumferentially located around the dowel so as to provide a good bonding surface with which to adhere to inside the hole drilled in the edge panel. In both aforementioned scenarios the precise location of both holes in both panels ensures that the two panels can be joined (or bonded) together in the proper location to each other and other surrounding relevant structures.

Where a wood screw is used to affix the edge panel to the surface panel, the screw is the sole mechanical interface by which the edge panel remains affixed to the surface panel. Accordingly, the strength of the joint between them is strictly dependent on the strength of the material into which the screw is inserted and the strength properties of the screw. The screw is the load bearing feature in this union. In this scenario the compressive forces generated by the screw between the two wooden panels are the only way by which the two panels remain affixed to each other.

Where the edge panel is affixed to the surface panel using a wooden dowel (a pin-type fastener), the adhesive bond between the solid wooden dowel and the interior circumference of both wooden panels is the sole mechanical means by which the dowel remains affixed to the panels. Accordingly, the adhesive bond between the dowel and the interior surfaces of the pre-drilled holes in both wooden panels is the only way that tension loads can be transmitted to the edge panel and the only way that the two panels remain affixed to each other. The shank of the dowel bonding the two panels together, and the strength of the adhesive bond between the interior of the holes in which it is placed, are the only way that loads are transferred between the two panels.

It is important to note that unlike the first aforementioned scenario (involving a wood screw) a bonded dowel pin-type fastener between two panels offers no clamping force between the panels before and after the adhesive-coated dowel is inserted, the joint must be pushed and held together with force during both the joining and curing phase of the adhesive-covered dowel by, for example, clamps or vises.

One way to join two honeycomb panels together (in such a manner, with one panel being on edge to the other) mimics the second aforementioned scenario involving wooden dowels and wooden panels: a textured-dowel (pin-type fastener) is used to join the two panels together and, in conjunction with an adhesive, creates a mechanical link between the two panels. However, unlike the solid wood edge panels referenced to in the aforementioned scenarios, the edge of a honeycomb edge panel does not offer any substantial material to which a precision pilot hole can be predrilled (prior to assembly) nor by which the dowel pin can hold to (prior to the application and curing of the adhesive), and because there is no interior circumferential surface in the pilot holes drilled into the honeycomb core (to which the adhesive is expected to adhere to) the two panels must be precisely located and clamped (or rigidly held together) prior to drilling the pilot hole on the edge panel. Accordingly, the use of exterior clamping mechanisms prior to bonding often precludes the practical, precise, measured location of the joint position, especially to the typical tolerances found in many applications, such as in the aerospace industry. Even after the textured dowel pin in inserted through the surface panel and into the edge of the honeycomb panel the paper-thin walls of the pre-drilled honeycomb core (in the edge panel) offer little to no grip strength to the dowel. Since the honeycomb core is easily crushed under a side load, this lack of structure in the walls of the honeycomb core allows the dowel to exit the edge honeycomb core and/or allows the edge panel to shift in location relative to the surface panel prior to adhesive infusion and curing.

The adhesive potting compound used in the above type of joint must be infused into the honeycomb core panels after they are rigidly held (clamped) in proper orientation. The adhesive potting compound must then be cured prior to release of the clamping force loads and prior to final dimensional inspection. The potting adhesive is infused around the body of the fastener (after it is positioned in between the panel skins of the honeycomb panel). Since two panels are being joined together with one fastener, and there are typically no way to infuse the adhesive potting compound into both panels prior to be joined and pinned together with a dowel. Therefore, the pin is constructed in such a manner as to allow the adhesive potting compound to be injected through a channel in the pin. Accordingly, in current methodologies involving the union of two honeycomb panels the architecture of the dowel (pin) also serves as a conduit to the adhesive potting compound such that the adhesive potting compound is infused into the honeycomb core of both panels simultaneously.

Often, the joining of two honeycomb panels at right angles (normal) to each other involves the use of pins (dowels) that are made out of hollow aluminum. These hollow aluminum tubes (often referred to as ‘panel pins’) have a surface texture on their periphery in order to provide a good bonding surface by which the cured potting adhesive can maintain a grip. These same panel pins also have holes drilled axially through their walls for the infusion of adhesive to the exterior of the panel pin and thus filling (potting) the cavities of the honeycomb core around the panel pins. This infused potting adhesive (when cured) creates a solid surface between the panel skins of the honeycomb core panel by which the panel pin can adhere. The adhesive bond between the cured adhesive and the outer texture of the panel pin provides the grip strength between the two honeycomb panels. If the cured adhesive fails to adequately bond to the surface texture of the panel pin, the joint will likely fail under tension.

What is needed is a system, method, and apparatus that will join honeycomb core panels to each other.

### SUMMARY

The improved fastener joins honeycomb panels where one honeycomb panel is positioned non-planer and on edge relative to the other honeycomb panel. The fastener provides a positive drawing and clamping force between the two honeycomb panels during assembly, precluding the need for exterior clamping forces to the panels to maintain proper position prior to curing. The fastener also provides for infusing of the adhesive potting compound into both honeycomb panels simultaneously thus providing a positively reinforced proper bond between the two panels. The fastener reduces the need of an adhesive bond between the fastener and the cured adhesive potting compound.

A method of joining two honeycomb core panels where one of the two panels is placed on edge, non-planer to the flat surface of the second panel, has the panels are held together by the fastener until the adhesive potting compound cures. The method includes making a through-hole normal to a surface of a honeycomb surface panel. A fastener is inserted into the through-hole and a panel non-planer edge of a second honeycomb core panel (herein referred to as the edge panel). The fastener has an exterior helix-threaded portion radially located along one section of the fastener's length captively engaging the honeycomb core walls of the edge panel to secure the edge panel to the surface panel by engaging the fastener with enough force to maintain proper position in relation to the surface panel and maintain edge panel's position during the cure cycle of the adhesive potting compound. The fastener has a hollow core that extends along the length of the fastener and a number of holes through the walls of the fastener in fluid communication with the hollow core, radially located along the axis of the fastener, preferably between the helix threads of the fastener. The holes allow the adhesive potting compound to properly infuse and fill honeycomb cells around the periphery of the fastener, both in the surface honeycomb panel and in the edge honeycomb panel.

The fastener and the adhesive potting compound (when cured), provide structural unions between the walls of the honeycomb core inside the two joined honeycomb panels. The fastener has interior and/or exterior surface design features for sharing and distributing any exterior shear, tension and/or torsional loads exerted against the newly-formed panel joint through the fastener and into the cured adhesive compound experiencing the same tension, shear and/or torsional loads against the inside features of the honeycomb panels.

In one embodiment, a honeycomb panel fastener for joining a first honeycomb panel to a second honeycomb panel, in which an edge of the second honeycomb panel is joined to a surface of the first honeycomb panel. The honeycomb panel fastener includes has an elongated body with a head at a first end of the elongated body and a point at a distal second end of the elongated body. The head has a larger outer dimension than a cross-sectional dimension across the elongated body. One or more threads are on an outside surface of the elongated body, arranged to pull the elongated body into the second honeycomb panel. A channel through the head traverses the elongated body. There are of bores in the elongated body, each of which is in fluid communications with the channel, such that, a fluid injected into the channel through the head flows through the channel and out of each of the plurality of bores. A torqueing feature is on a surface of the head enabling twisting of the head and, consequently, the honeycomb panel fastener.

In another embodiment, a method of method of joining a surface of a first honeycomb panel to an edge of a second honeycomb panel is disclosed including providing a honeycomb panel fastener. The honeycomb panel fastener has an elongated body with a head at a first end of the elongated body and a point at a distal second end of the elongated body. The head has a larger outer dimension than a cross-sectional dimension across the elongated body. One or more threads are on an outside surface of the elongated body, arranged to pull the elongated body into the second honeycomb panel. A channel through the head traverses the elongated body. There are of bores in the elongated body, each of which is in fluid communications with the channel, such that, a fluid injected into the channel through the head flows through the channel and out of each of the plurality of bores. A torqueing feature is on a surface of the head enabling twisting of the head and, consequently, the honeycomb panel fastener. The method continues with inserting the point of the honeycomb panel fastener through a hole in the first honeycomb panel at a point where an edge of the second honeycomb panel abuts a planar surface of the first honeycomb panel. A driver is then interfaced to the torqueing feature and rotated, thereby rotating the honeycomb panel fastener so that the point pierces the edge of the second honeycomb panel and the at least one threads draws the honeycomb panel fastener into the edge of the second honeycomb panel. The rotation of the driver is stopped when the head interfaces to an outer surface of the first honeycomb panel and the edge of the second honeycomb panel interfaces to an opposing second surface of the first honeycomb panel, at which time the driver is removed from the torqueing feature and an adhesive (fluid) is injected through the head and into the channel, such that the adhesive oozes out of the bores, filling airspaces that surround the honeycomb panel fastener in both the first honeycomb panel and the second honeycomb panel. The adhesive is allowed to cure, thereby joining the first honeycomb panel and the second honeycomb panel.

In another embodiment, a honeycomb panel system is disclosed including a first honeycomb panel, a second honeycomb panel and a fastener for joining the first honeycomb panel to the second honeycomb panel, such that an edge of the second honeycomb panel is joined to a surface of the first honeycomb panel. The honeycomb panel fastener has an elongated body with a head at a first end that has a larger outer dimension than a cross-sectional dimension across the elongated body. A point is at a distal second end of the elongated body. A helix thread is on an outside surface of the elongated body, arranged to pull the elongated body into the second honeycomb panel. A channel through the head traverses the elongated body such that a plurality of bores in the elongated body is in fluid communications with the channel. A fluid injected into the channel through the head flows through the channel and out of each of the plurality of bores. A torqueing feature on a surface of the head enables twisting of the head and, consequently, the honeycomb panel fastener.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates an exploded, perspective view of a honeycomb core panel;

FIG. 2 illustrates a perspective view of two honeycomb core panels in non-planer relationship to each other ready to be joined;

FIG. 3 illustrates a perspective view of the two honeycomb core panels abutted in non-planer orientation to each other in an exemplary desired panel joint configuration;

FIG. 4 illustrates a perspective view of the two honeycomb core panels in non-planer orientation to each other with a fastener ready for insertion;

FIG. 5 illustrates a cut-away perspective view of the two honeycomb core panels after insertion of the fastener;

FIG. 6 illustrates a perspective view of the two honeycomb core panels after insertion of the fastener;

FIG. 7 illustrates a cross-sectional view of the two honeycomb core panels in non-planar relationship to each other after insertion of the fastener into the honeycomb core panels, with an exemplary adhesive potting joint compound delivery head;

FIG. 8 illustrates a cross-sectional view of the two honeycomb core panels in non-planar relationship to each other after insertion of the fastener into the honeycomb core panels, with partial delivery of the adhesive potting joint compound;

FIG. 9 illustrates a cross-sectional view of the two honeycomb core panels in non-planar relationship to each other after insertion of the fastener into the honeycomb core panels, with completed delivery of the adhesive potting joint compound into the honeycomb core panels;

FIG. 10 illustrates a side perspective view of the fastener;

FIG. 11 illustrates a top perspective view of a portion of the fastener;

FIG. 12 illustrates a bottom perspective view of a portion of the fastener;

FIG. 13 illustrates a bottom perspective view of a portion of the fastener;

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

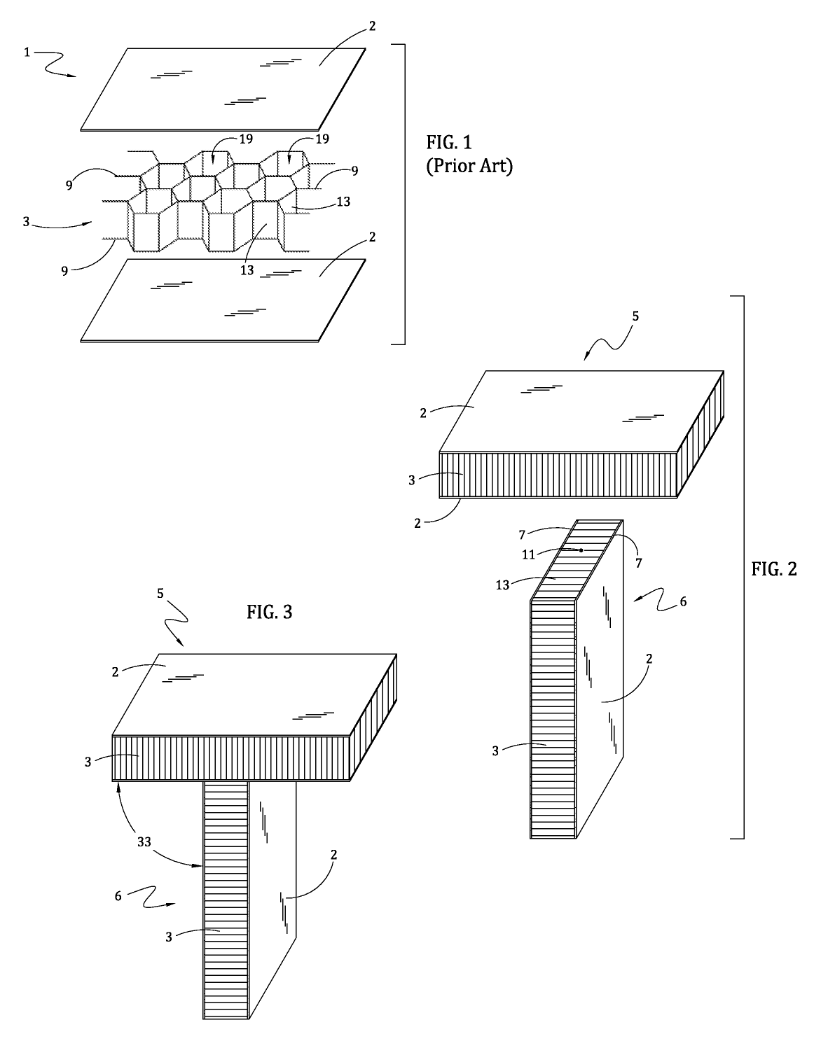

Referring to FIG. 1, an exploded, perspective view of a honeycomb core panel 1 of the prior art is shown. The honeycomb core panels 1 typically consist of a core 3 having walls 13 formed in the shape of a honeycomb that have, typically, hexagonal cross-sectional cavities 19. The walls 13 have edges 9 onto which surface sheets 2 are bonded. The cavities 19 are typically air spaces, providing for a light weight honeycomb core panel 1 that provides structural strength where minimum mass is needed such as in vehicles or aircraft in which fuel consumption is proportional to the vehicle or aircraft weight. Such panels have been widely used in such applications, providing strong, yet light weight, panels.

Referring to FIGS. 2 and 3, two honeycomb panel(s) 5/6 are shown at angles to each other, ready to be fastened. Each honeycomb panel 5/6 consists of two surface sheet(s) 2 and a honeycomb core 3 bonded to the surface sheets 2 as described in FIG. 1. A first honeycomb panel 5, herein referred to as the honeycomb core surface panel 5 is positioned to be affixed to a second honeycomb panel 5, herein referred to as the honeycomb core edge panel 6 along edges 7 at an angle 33 such as an angle 33 that is less than or equal to 90°.

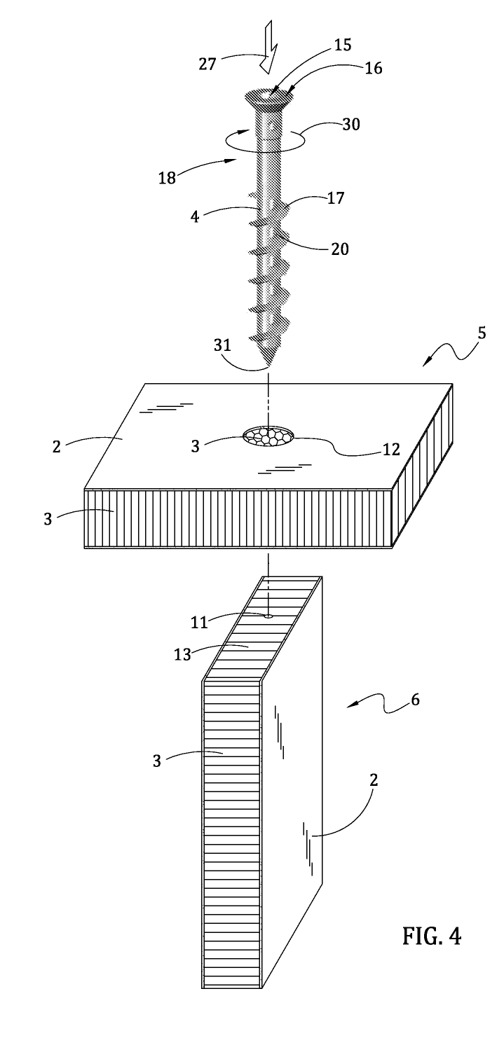

Referring now to FIG. 4, a fastener 4 is inserted into a through-hole 12 in the honeycomb core surface panel 5 that is formed/made axially into and through the surface sheets 2 and the honeycomb core 3. The fastener 4 is inserted through honeycomb core surface panel 5 and into the honeycomb core walls 13 of the honeycomb core edge panel 6 at location 11. Using a head torqueing feature 15 (e.g. driver head, Philips head, etc.) on the head 16 of fastener 4, a torsional force 30 and axial thrust force 27 is applied to head 16 of the fastener 4 causing the tip 31 of the fastener 4 to puncture and enter the honeycomb core 3 on the honeycomb core edge panel 6, passing through the honeycomb core wall 13 and deeper, into a number of the honeycomb core cavities 19. As the torsional force 30 and thrust force 27 are applied, the fastener 4 threads deeper into the honeycomb core edge panel 6, pulled by the threads 17 of the fastener.

In the embodiment of the fastener 4 shown, the head 16 is shown as a flat-head, counter-sunk type head 16, however the head 16 is anticipated to be formed in any configuration typical of fastener heads including, but not limited to, button, oval, pan, round, hex and/or socket cap screw head. In the embodiment shown, the head 16 driver torqueing feature 15 is shown as a TORX™ driver, however any type or combination of driver torqueing feature 15 is anticipated, including but not limited to Phillips, Slot-head, Robertson and/or Allen head.

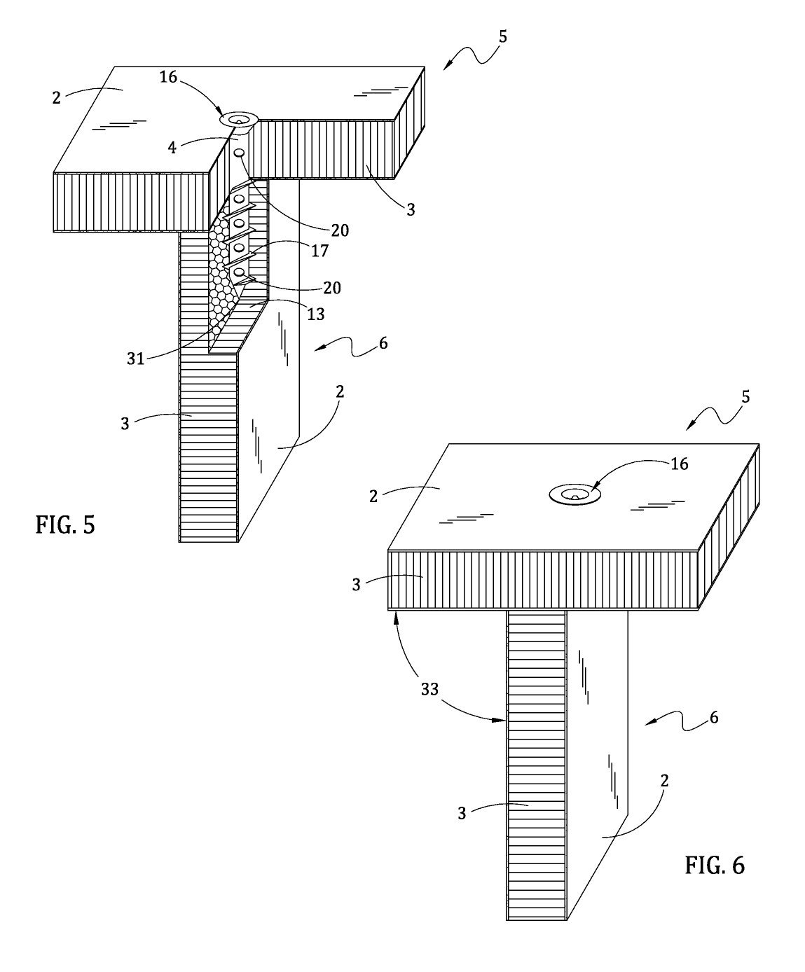

With the continued application of torsional load 30 to the fastener 4, the threads 17 (e.g. helix threads 17) on the exterior body of the fastener 4 engage with the honeycomb core wall 13 as shown in FIG. 5 until the head 16 abuts with or rests on/in the honeycomb core surface panel 5. At this point, in a preferred embodiment, the threads 17 are located beyond the honeycomb core surface panel 5 and the unthreaded portion 18 of the fastener 4 is positioned within the honeycomb core edge panel 6. The length of the unthreaded portion 18 is typically selected to be relative to the thickness of the honeycomb core surface panel 5. The unthreaded portion 18 reduces free-spin and binding of the honeycomb core surface panel 5. This unthreaded portion 18 allows the entire clamping force generated by the torsional force 30 through the fastener 4 along the threads 17 to be generated between the head 16 of the fastener 4 and the threads 17 positioned within the honeycomb core edge panel 6.

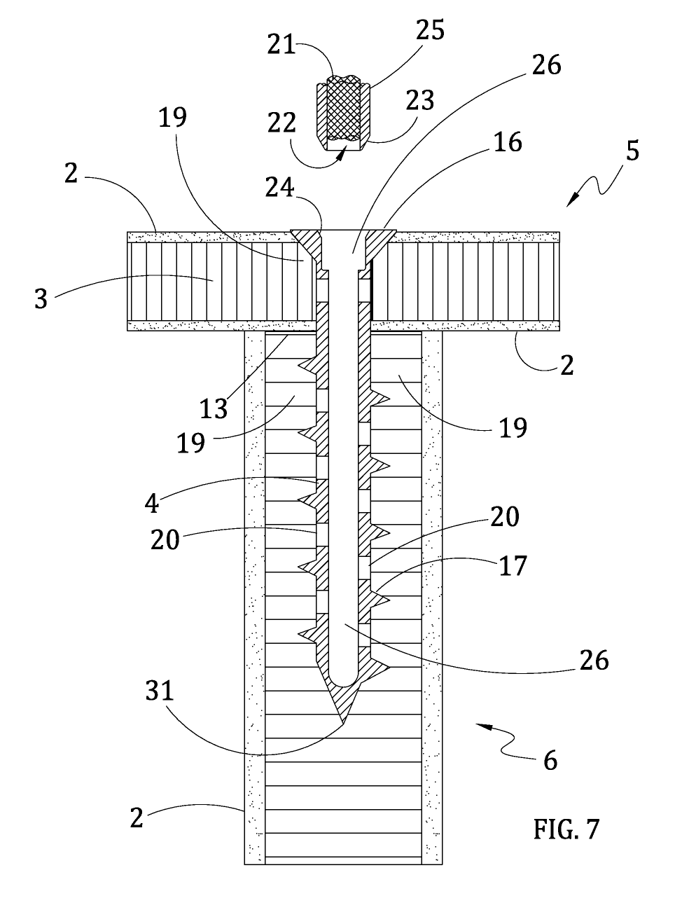

As torsional force 30 is applied to the fastener 4, the threads 17 cut into the honeycomb core wall 13 of the honeycomb core edge panel 6, drawing the honeycomb core edge panel 6 towards the honeycomb surface panel 5 until edges 7 of the honeycomb core edge panel 6 come into contact with the surface sheet 2 of the honeycomb surface panel 5. The threads 17, being engaged within the honeycomb core walls 13 of the honeycomb core edge panel 6, maintain a compressive load between the honeycomb core edge panel 6 and the honeycomb core surface panel 5, thus eliminating or reducing the need for supplemental clamping devices previously used. The compressive load maintains proper alignment and position of the honeycomb core surface panel 5 and the honeycomb core edge panel 6 before and during injection of an adhesive potting compound 21 (see FIGS. 7-9) and during cure of adhesive potting compound 21. With this joint system, if the position of the honeycomb core edge panel 6 is not in the desired location relative to the honeycomb core surface panel 5, the fastener 4 is removed by applying a reverse torsional force (opposite in direction to torsional force 30) causing the fastener 4 to disengaged from the honeycomb core edge panel 6. The honeycomb core edge panel 6 is then properly relocated relative to the honeycomb core surface panel 5 and the aforementioned joining process is repeated.

It is fully anticipated that, although shown in a specific arrangement, the tip 31 of fastener 4 and the threads 17 of the fastener are of any design, radial length, and configuration to optimize the performance of the fastener, the design of such specific to the type of honeycomb core panels 1. The tip 31 and threads 17 represent one of many possible configurations designed to puncture and engage honeycomb core panels 1.

Referring now to FIGS. 7-9, cross-sectional views of the honeycomb core panels 5/6 are shown after insertion of the fastener, with various stages of adhesive potting joint compound delivery. After the fastener 4 is properly seated, an adhesive potting compound 21 is injected into and through the fastener 4 from an opening 22 in a head 25 of an adhesive delivery system (not shown). In some embodiments, the fastener 4 has a mating feature 24 designed to engage a complimentary mating feature 23 on adhesive delivery system head 25 by which head 25 engages with fastener 4 so that adhesive 21 flows from the opening 22 in the head 25 and into/through a cavity 26 within the interior of the fastener 4. Although the mating features 23/24 are shown as a conical taper, in alternate embodiments, any mating features 23/24 are anticipated including, but not limited to, mating features 23/24 without a conical taper, etc.

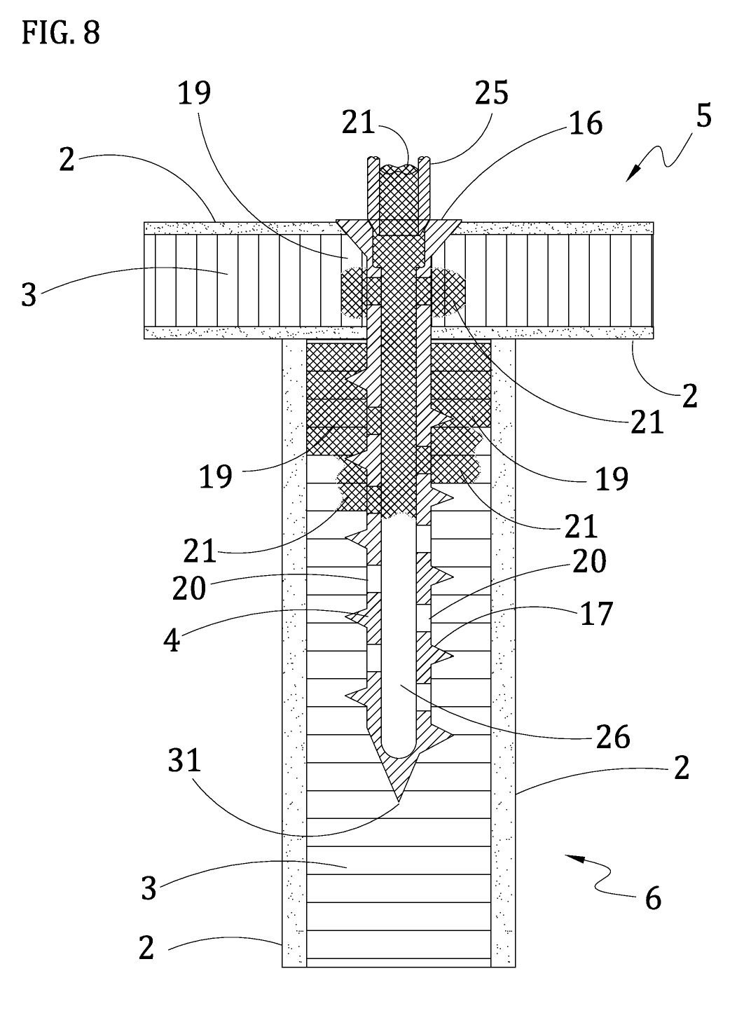

As shown in FIG. 8, after the adhesive delivery head 25 properly interfaces with the head 16 of the fastener 4, adhesive 21 is injected through the head 25 and into the cavity 26 of the fastener 4. As the adhesive 21 flows, some of the adhesive 21 exits the cavity 26 through one or more radial through-holes 20 positioned along the length of the fastener 4, flowing out of the fastener 4 and into the cavities 19 of the honeycomb core edge panel 6. The radial through-hole(s) 20 are preferably positioned between the threads 17. Any number and/or size of through-hole(s) 20 are anticipated, typically selected based upon the pitch and length of engagement of the threads 17 along the exterior of the fastener 4. In some embodiments, one or more additional through-hole(s) 20 in the unthreaded portion 18 of fastener 4 are provided to allow some of the adhesive 21 to exit into the honeycomb core surface panel 5.

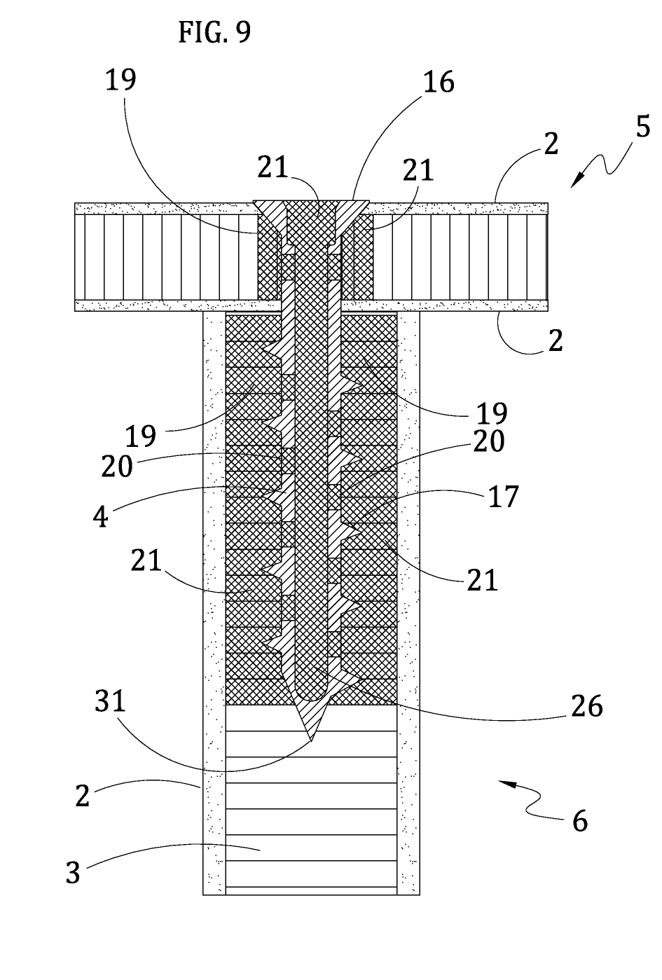

As the adhesive 21 exits the fastener 4, the adhesive 21 occupies the cavities 19 within the honeycomb core edge panel 6 adjacent to the fastener 4 and an area surrounding the unthreaded portion 18 of the fastener 4 located within the honeycomb core surface panel 5. Preferably, the adhesive 21 is injected into the fastener 4 until the adhesive 21 fills all or most cavities 19 between the surface sheets 2 of the honeycomb core edge panel 6, as well as filling an area around the unthreaded portion 18 of the fastener 4 located within the honeycomb core surface panel 5, as shown in FIG. 9.

Note that, as shown, it is preferred that the tip 31 of the fastener 4 is solid, and therefore the adhesive 21 does not exit through the tip 31.

Upon completion of injection of the adhesive 21 into/through the fastener 4 and into the cavities 19 in both the honeycomb core surface panel 5 and the honeycomb core edge panel 6, the head 25 is disengaged from the mating feature 24 and the adhesive 21 is allowed to cure, the bonding the honeycomb core surface panel 5 to the honeycomb core edge panel 6.

Once cured, the head 16 on the fastener 4 provides for a positive mechanical stop to tension loads between the honeycomb core surface panel 5 and the honeycomb core edge panel 6 by transferring the tension load though the fastener 4 evenly across the cured adhesive potting compound 21. The cured adhesive potting compound 21 subsequently transfers the tension loads (evenly) through the cavities 19, which are now encapsulated by cured adhesive potting compound 21, to the panel sheets 2 of the honeycomb core surface panel 5. The cured adhesive potting compound 21 also transfers this tension load from the fastener 4 through the cured adhesive potting compound 21 surrounding the unthreaded portion 18 of the fastener 4 located within the honeycomb core surface panel 5 to the panel sheets 2 of the honeycomb core surface panel 5 resulting in a compressive load to the interior of the honeycomb core surface panel 5. The load is thereby distributed by the cured adhesive to both sides of honeycomb core edges 9 and both inside surfaces of the panel sheets 2 of the honeycomb core surface panel 5.

Torsional loads applied to either the honeycomb core surface panel 5 or to the honeycomb core edge panel 6 are transmitted by the cured adhesive potting compound 21 within honeycomb core cavities 19 through the through-holes 20 and into the fastener 4 and the cavity 26. The torsional loads become normal to the cured adhesive potting compound 21 now occupying through-holes 20 and said torsional loads are transmitted as shear loads across the cross-section of cured adhesive potting compound 21. The cured adhesive potting compound 21 becomes a complex, one-piece, 3-dimensional structure intertwined with the fastener 4, the fastener cavity 26, the through-holes 20 and, the honeycomb core surface panel 5, and the honeycomb core edge panel 6. The strength of this one-piece, 3-dimensional cured structure is dependent on the mechanical properties of the cured adhesive potting compound 21, to which higher ratings for torsional loads applied to either the honeycomb core surface panel 5 or the honeycomb core edge panel 6 are increased by using an adhesive potting compound 21 with higher [stronger] mechanical properties. In such, any need for surface adhesion of the adhesive potting compound 21 to any surface it comes in contact with is reduced.

Tension loads applied between the honeycomb core surface panel 5 are transmitted via cured adhesive potting compound 21 to a normal load on the head 16, threads 17 and the panel sheets 2 on the honeycomb core edge panel 6. The rated tension load is increased by a corresponding increase in the material properties of the fastener 4 (e.g. stronger materials). Such reduces or precludes the need for optimum surface adhesion of the adhesive potting compound 21 to any surface, including surfaces of the fastener 4.

Shear load(s) transmitted to either the honeycomb core surface panel 5 of the honeycomb core edge panel 6 are transmitted through the fastener 4 and the cured adhesive potting compound 21 in the fastener cavity 26. Therefore, the rated shear load is increased with corresponding increases in material mechanical properties of either or both the fastener 4 and/or the cured adhesive potting compound 21. Such reduces or precludes the need for optimum surface adhesion of the adhesive potting compound 21 to any surface it contacts.

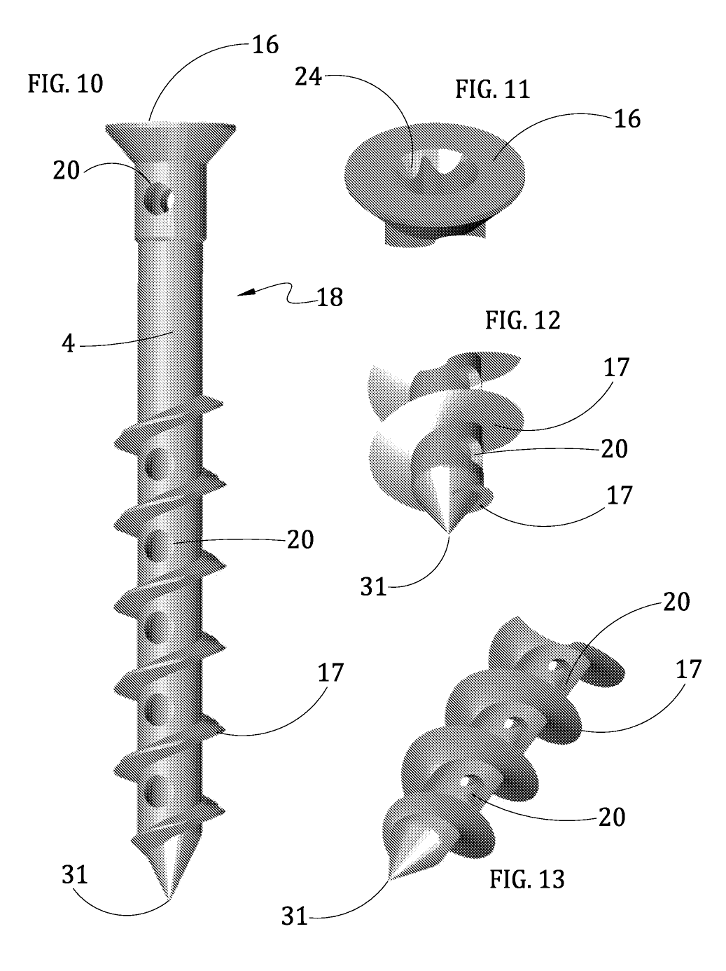

FIGS. 10-13 show detailed perspective views of an exemplary embodiment of the fastener 4 for joining two honeycomb panels 1. Again, by design choice, any number, size, shape, location, angle, and pitch of each feature is fully anticipated. As an example, but not limiting, the through-hole shape is oval or the thread pitch is more or less, etc. As shown in FIGS. 10-13, the fastener 4 has an elongated body that has a hollow cavity 26 within for distribution of the adhesive potting compound 21. Along at least a portion of the elongated body is one or more threads 17. At one end of the elongated body is a point 31 and at the distal end of the elongated body is a head 16 having a torqueing interface (e.g., Phillips, flat, box) that extends openly into the hollow cavity 26. The torqueing feature 15 is for interfacing with a driver (e.g. a screwdriver). The head 16 preferably has a larger outer dimension than a cross-sectional dimension of the elongated body. A plurality of holes 20 are in fluid communications with the hollow cavity 26, thereby conducting the adhesive potting compound 21 from the interior hollow cavity 26 of the fastener 4 to an area outside of the fastener 4 so that the adhesive potting compound 21 fills voids in the

The invention in its broader aspects is not limited to the specific details and representative embodiments shown in the fastener 4. Accordingly, various modifications to the features of the fastener 4 are anticipated without departing from the spirit or scope of the general concepts as defined by the appended claims and their equivalents.

Note that the bonding material referred to as adhesive potting compound 21 is not limited to any particular adhesive and/or potting material or combination of adhesives and/or potting materials.

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A honeycomb panel fastener for joining a first honeycomb panel to a second honeycomb panel, an edge of the second honeycomb panel joined to a surface of the first honeycomb panel, the honeycomb panel fastener comprising:
an elongated body;
a head at a first end of the elongated body, the head having a larger outer dimension than a cross-sectional dimension across the elongated body;
a point at a distal second end of the elongated body;
one or more threads on an outside surface of the elongated body, the threads arranged to pull the elongated body into the second honeycomb panel;
a channel passing through the head and traversing the elongated body;
a plurality of bores in the elongated body, each of the plurality of bores in fluid communications with the channel, such that, a fluid injected into the channel through the head flows through the channel and out of each of the plurality of bores; and
a torqueing feature on the head enabling twisting of the head and, consequently, the honeycomb panel fastener.

2. The honeycomb panel fastener of claim 1, wherein the one or more threads is one or more helix threads.

3. The honeycomb panel fastener of claim 1, wherein the one or more threads is one helix thread.

4. The honeycomb panel fastener of claim 3, wherein the one helix thread starts at a location separated from the head by a distance creating an area on the elongated body void of threads.

5. The honeycomb panel fastener of claim 4, wherein the distance is approximately equal to a width of the first honeycomb panel.

6. The honeycomb panel fastener of claim 3, wherein a subset of the plurality of bores is located between the threads and a second subset of the plurality of bores is located in proximity of the head.

7. The honeycomb panel fastener of claim 1, wherein the head is chamfered at an edge of the channel for mating with a similar surface of a device for injecting an adhesive into the channel.

8. The honeycomb panel fastener of claim 1, wherein the torqueing feature is a square box for interfacing with a square driver.

9. The honeycomb panel fastener of claim 1, wherein the torqueing feature is a hexagonal indentation for interfacing with a driver.

10. A method of joining a surface of a first honeycomb panel to an edge of a second honeycomb panel, the method comprising:
providing a honeycomb panel fastener comprising:
an elongated body;
a head at a first end of the elongated body, the head having a larger outer dimension than a cross-sectional dimension across the elongated body;
a point at a distal second end of the elongated body;
one or more threads on an outside surface of the elongated body, the threads arranged to pull the elongated body into the second honeycomb panel;
a channel passing through the head and traversing the elongated body;
a plurality of bores in the elongated body, each of the plurality of bores in fluid communications with the channel, such that, a fluid injected into the channel through the head flows through the channel and out of each of the plurality of bores;
a torqueing feature on a surface of the head enabling twisting of the head and, consequently, the honeycomb panel fastener;
inserting the point of the honeycomb panel fastener through a hole in the first honeycomb panel at a point where an edge of the second honeycomb panel abuts a planar surface of the first honeycomb panel;
interfacing a driver to the torqueing feature;
rotating the driver, thereby rotating the honeycomb panel fastener;
the point piercing the edge of the second honeycomb panel, the at least one threads drawing the honeycomb panel fastener into the edge of the second honeycomb panel;
stopping of the rotating of the driver when the head interfaces to an outer surface of the first honeycomb panel and the edge of the second honeycomb panel interfaces to an opposing second surface of the first honeycomb panel;
removing the driver from the torqueing feature;
inserting adhesive through the head and into the channel, such that the adhesive oozes out of the bores, filling airspaces that surround the honeycomb panel fastener in both the first honeycomb panel and the second honeycomb panel; and
curing the adhesive, thereby joining the first honeycomb panel and the second honeycomb panel.

11. The method of claim 10, wherein the one or more threads is one helix thread.

12. The method of claim 11, wherein, after stopping of the rotating of the driver, the one helix thread is positioned within the second honeycomb panel and the an area on the elongated body that is void of threads is positioned within the first honeycomb panel.

13. The method of claim 10, wherein a subset of the plurality of bores is located between the threads and a second subset of the plurality of bores is located in proximity of the head.

14. The method of claim 10, wherein the step of inserting adhesive provides sufficient adhesive and includes the step of filling the cavities within the second honeycomb panel located along the elongated body of the honeycomb panel fastener from a first surface of the second honeycomb panel to a second, opposing surface of the second honeycomb panel.

15. A honeycomb panel system comprising:
a first honeycomb panel;
a second honeycomb panel,
a fastener for joining the first honeycomb panel to the second honeycomb panel, such that an edge of the second honeycomb panel is joined to a surface of the first honeycomb panel, the honeycomb panel fastener comprising:
an elongated body;
a head at a first end of the elongated body, the head having a larger outer dimension than a cross-sectional dimension across the elongated body;
a point at a distal second end of the elongated body;
a helix thread on an outside surface of the elongated body, the helix thread arranged to pull the elongated body into the second honeycomb panel;
a channel passing through the head and traversing the elongated body;
a plurality of bores in the elongated body, each of the plurality of bores in fluid communications with the channel, such that, a fluid injected into the channel through the head flows through the channel and out of each of the plurality of bores; and
a torqueing feature in the head enabling twisting of the head and, consequently, the honeycomb panel fastener.

16. The honeycomb panel system of claim 15, wherein the helix thread starts at a location on the elongated body separated from the head by a distance creating an area on the elongated body void of helix threads.

17. The honeycomb panel system of claim 16, wherein the distance is approximately equal to a width of the first honeycomb panel.

18. The honeycomb panel system of claim 17, wherein a subset of the plurality of bores is located on the elongated body between the threads and a second subset of the plurality of bores is located on the elongated body in proximity of the head.

19. The honeycomb panel system of claim 15, wherein the torqueing feature is a square box for interfacing with a square driver.

20. The honeycomb panel system of claim 15, wherein the torqueing feature is a Phillips head for interfacing with a Phillips head screwdriver.
